(19) United States
(12) Patent Application Publication
(10) Pub. No.: US 2017/0271697 A1
(43) Pub. Date: Sep. 21, 2017

(54) MEMBRANE ELECTRODE ASSEMBLY, AND ELECTROCHEMICAL CELL AND ELECTROCHEMICAL STACK USING SAME

(71) Applicants: Sang Bong Moon, Seoul (KR); Elchemtech Co., Ltd., Seoul (KR)

(72) Inventors: Sang Bong MOON, Seoul (KR); Hye Young JUNG, Seoul (KR); Yun Ki CHOI, Seoul (KR); Chang Hwan MOON, Seoul (KR)

(21) Appl. No.: 15/080,783

(22) Filed: Mar. 25, 2016

(30) Foreign Application Priority Data
Mar. 21, 2016 (KR) 10-2016-0033567

(51) Int. Cl. H01M 8/1004; H01M 8/242; H01M 4/88; H01M 8/1039; H01M 4/92; H01M 8/0273; H01M 8/1023

(52) U.S. Cl. CPC H01M 8/1004; H01M 8/0273; H01M 8/242; H01M 8/1023; H01M 8/1039; H01M 4/921; H01M 4/926; H01M 4/881; H01M 2008/1095

(57) ABSTRACT

Disclosed is a membrane electrode assembly that includes a polymer electrolyte membrane, a first electrochemical reaction layer formed on one side of the polymer electrolyte membrane to allow an oxidation reaction to occur thereon, a first electron-conductive layer formed between the polymer electrolyte membrane and the first electrochemical reaction layer, a second electrochemical reaction layer formed on a remaining side of the polymer electrolyte membrane to allow a reduction reaction to occur thereon, and a second electron-conductive layer formed between the polymer electrolyte membrane and the second electrochemical reaction layer.

### BACKGROUND OF THE INVENTION

1. Field of the Invention

The present invention relates to a membrane electrode assembly and an electrochemical cell and an electrochemical stack using the same. More particularly, the present invention relates to a membrane electrode assembly and an electrochemical cell and an electrochemical stack using the same, in which the membrane electrode assembly is formed to be very compact to thus significantly reduce operating costs, the number of parts is reduced to thus reduce manufacturing costs, and the number of contact points is reduced to thus reduce electricity consumption during electrolysis.

2. Description of the Related Art

Generally, an electrochemical cell is an energy converter that uses electric energy or generates electric energy, and is classified into an electrolytic cell and a fuel cell. In order to put the electrochemical cell to practical use, the fuel cell needs to have improved output density (reduced electric energy consumption in the case of water electrolysis), improved durability, and a low price.

FIGS. 1 to 4 show a unit structure of a typical electrochemical cell, an electrochemical stack structure, and a system structure.

FIG. 1 is a view showing the concept of a membrane electrode assembly 100 which constitutes a portion of typical electrolytic cell, which electrochemically decomposes water to generate hydrogen and oxygen gases. FIG. 1 shows the thickness of the layer of each of the elements at a lower part thereof.

The electrochemical cell for electrolysis, which electrolyzes water (H₂O) to generate oxygen gas (O₂) and hydrogen gas (H₂), includes a first electrochemical reaction layer 104, a second electrochemical reaction layer 108, membrane 106, a first diffusion layer 102, and a second diffusion layer 110. The first electrochemical reaction layer 104 includes a first electrochemical catalyst 112 and a first carrier 114, and the second electrochemical reaction layer 108 includes a second electrochemical catalyst 116 and a second carrier 118.

The first diffusion layer 102 and the second diffusion layer 110 help to move electrons, reactants, or products to or from the first and the second electrochemical catalysts 112 and 116. The first and the second electrochemical catalysts 112 and 116 are the most important materials that are used to perform electrolysis or generate electric energy, and the first and the second carriers 114 and 118 function to support the first and the second electrochemical catalysts 112 and 116 and provide an electron movement path.

The first and the second electrochemical catalysts 112 and 116 are mixed with the first and the second carriers 114 and 118, a binder, and a solvent to form a slurry or paste, which is then applied on the membrane 106 or on the first and the second diffusion layers 102 and 110 to form the first and the second electrochemical reaction layers 104 and 108. The manufactured assembly of “electrochemical reaction layers 104 and 108-membrane 106” or “electrochemical reaction layers 104 and 108-membrane 106-diffusion layers 102 and 110” is called a membrane electrode assembly (hereinafter, referred to as “MEA”).

The interval between the first electrochemical reaction layer 104 and the second electrochemical reaction layer 108, which are formed in the MEA, has a physical thickness value of the membrane. Bubbles are not present in the first electrochemical reaction layer 104 or in the second electrochemical reaction layer 108, thereby making it possible to perform high-current operation at low voltages. Further, since the conductivity of an electrolyte solution is not used, unlike in an alkali electrolytic cell, water, which is a raw material, may be used while ensuring high purity, and accordingly, high-purity hydrogen and oxygen may be obtained.

The process of electrolyzing water will be described below using the constitution shown in FIG. 1. The place at which an oxidation reaction occurs is considered the first electrochemical reaction layer 104, and the place at which a reduction reaction occurs is considered the second electrochemical reaction layer 108. The oxidation and reduction reactions occur simultaneously.

First, when water (H₂O) is supplied through the first diffusion layer 102 to the first electrochemical reaction layer 104, the water is decomposed into oxygen gas (O₂), electrons (e⁻), and hydrogen ions (H⁺) (protons) at the first electrochemical catalyst 112 (also called an oxidation catalyst, an anode active material, or an oxygen-gas generating electrode), as shown in the following Reaction Scheme 1. The oxygen gas (O₂) is discharged to the outside of the electrolytic cell via diffusion, and the hydrogen ions (H⁺) are moved through the membrane 106 to the second electrochemical catalyst 116 (also called a reduction catalyst, a cathode active material, or a hydrogen-gas generating electrode) by an electric field. The electrons (e⁻), which are generated due to the aforementioned reaction, are moved from the first electrochemical catalyst 112 through the first diffusion layer 102 and an external circuit (not shown) to the second diffusion layer 110 and the second electrochemical catalyst 116.

Meanwhile, the hydrogen ions (H⁺) and the electrons (e⁻), which are moved from the first electrochemical catalyst 112, react at the second electrochemical catalyst 116 to generate hydrogen gas (H₂), as shown in Reaction Scheme 2. In addition, a portion of the water supplied to the first electrochemical reaction layer 104 is moved to the second electrochemical reaction layer 108 by an electric field to thus be discharged together with the hydrogen gas (H₂) to the outside of the electrolytic cell.

The electrochemical reactions, which occur at the first electrochemical catalyst 112 and the second electrochemical catalyst 116, are shown in the following Reaction Schemes 1 and 2.

2H₂O→4H⁺+4e⁻+O₂ (Anode) [Reaction Scheme 1]

4H⁺+4e⁻→2H₂ (Cathode) [Reaction Scheme 2]

Meanwhile, a reverse reaction of electrolysis of water occurs in the fuel cell, and will be described below.

First, hydrogen gas is introduced into a first electrochemical reaction layer, and oxygen gas is supplied to a second electrochemical reaction layer. The hydrogen gas is then converted into hydrogen ions (proton) and electrons via an electrochemical reaction at a first electrochemical catalyst, and the electrons are moved through an external load, which is electrically connected to the fuel cell, and the protons are moved through a membrane to a second electrochemical catalyst. The protons and the electrons, which are generated at and moved from the first electrochemical catalyst, react with oxygen gas, which is supplied from the outside, at the second electrochemical catalyst to generate water, energy, and heat. This is referred to as the overall electrochemical reaction.

FIG. 2 is a view showing the structure of a typical electrochemical cell which includes the MEA of FIG. 1 to electrolyze water. An electrochemical cell 200, like that shown in FIG. 2, includes a first end plate 202, a first insulating plate 204, a first current application plate 206, a first electrochemical reaction chamber frame 208, a first electrochemical reaction chamber 210, the MEA 100 of FIG. 1, a second electrochemical reaction chamber 212, a second electrochemical reaction chamber frame 214, a second current application plate 216, a second insulating plate 218, and a second end plate 220. A direct current power supply is used as a power converter 224, which applies current to the electrochemical cell.

The first end plate 202 and the second end plate 220 have bolt/nut fastening holes (not shown) for assembling the unit electrochemical cells, and provide paths (not shown) through which reactants and products are moved. The first insulating plate 204 and the second insulating plate 218 provide an electric insulation function between the first end plate 202 and the first current application plate 206 and between the second end plate 220 and the second current application plate 216. The first current application plate 206 and the second current application plate 216 are connected to the power converter 224 to apply required current to the electrochemical cell 200.

Meanwhile, when the first electrochemical catalyst 112 is positioned in the first electrochemical reaction chamber 210 to allow an oxidation reaction to occur, the first electrochemical reaction chamber 210 becomes a space through which water, as the reactant, and oxygen, as the product, are moved. The second electrochemical reaction chamber 212, which is positioned at the opposite side of the first electrochemical reaction chamber 210 while the membrane 106 is interposed between the first and the second electrochemical reaction chambers, provides a space through which hydrogen, which is generated in the reduction reaction, and water, which is moved from the first electrochemical reaction chamber 210, are moved.

The first electrochemical reaction chamber 210 is isolated from the outside by the first electrochemical reaction chamber frame 208, and the second electrochemical reaction chamber 212 is isolated from the outside by the second electrochemical reaction chamber frame 214. In addition, a gasket (or packing) 222 is provided between the MEA 100 and the first electrochemical reaction chamber frame 208 and between the MEA 100 and the second electrochemical reaction chamber frame 214 in order to prevent the reactants and the products from leaking to the outside.

Among the elements constituting the electrochemical cell 200, the first electrochemical reaction chamber frame 208, the second electrochemical reaction chamber frame 214, and the gasket 222 have predetermined holes, through which the reactants or the products are easily supplied to and discharged from the electrochemical cell. The first electrochemical reaction chamber frame 208 and the second electrochemical reaction chamber frame 214 have fluid paths (represented by the dotted line in (A) of FIG. 2) for fluid (oxygen, hydrogen, and water).

Meanwhile, another electrochemical cell 200 may have a pressure pad (not shown, refer to 304 of FIG. 3) between the second electrochemical reaction chamber frame 214 and the second current application plate 216 so as to maintain the balance of the electrochemical cell 200.

FIG. 3 is a view showing the concept of a known electrochemical stack. A plurality of unit electrochemical cells is required in order to obtain a desired amount of products during an electrolysis reaction, and an assembly of the two or more layered electrochemical cells is called an electrochemical stack.

When the electrochemical cells are layered in order to constitute the electrochemical stack 300 shown in FIG. 3, unit electrochemical cells are repeatedly disposed in a desired number between the basic electrochemical cells 200. A pressure pad 304 is interposed between the unit electrochemical cells in order to press the elements to each other. Bolts 306 are fastened with nuts 310 through holes, which are formed through edges of the first and the second end plates 202 and 220, in order to assemble the unit electrochemical cells in the electrochemical stack.

FIG. 4 is a view showing a system for electrolyzing water using the electrolysis stack that is the same as the electrochemical stack of FIG. 3 in order to produce hydrogen. A hydrogen-generating system 400, as shown in FIG. 4, includes an electrolysis stack 420, a water-treating unit for treating water, which is supplied to the electrolysis stack 420, and a gas-treating unit for purifying hydrogen gas, which is generated from the electrolysis stack 420, and controlling pressure.

Pure water of 1 Mega ohm cm or more is used as water, which is a raw material used in the electrolysis stack 420. An automatic valve 402, which is provided in a pure water-supplying line s1, is adjusted to supply pure water, and the automatic valve 402 is controlled using a level sensor 405, which is used to sense the level, in an oxygen-water separation bath 404 (dotted line e2). Water is supplied from the oxygen-water separation bath 404 to the electrolysis stack 420 using a circulation pump 406, which is provided in a circulation pipe s2, joins water circulating through a circulation line s9 from a hydrogen-water separation bath 424, and then passes through a pipe in which a heat exchanger 408, a water-quality sensor 410, and an ion-exchanging filter 412 are provided. The water is then supplied to a first electrochemical reaction chamber 414 (the place in which an oxidation reaction occurs) of the electrolysis stack 420. Meanwhile, when direct current is supplied from a power converter 440 through a wire e1 to the electrolysis stack 420, the water undergoes a decomposition reaction.

Oxygen, which is generated from the first electrochemical reaction chamber 414, and unreacted water are moved through a discharge pipe s4 to the oxygen-water separation bath 404, and a temperature sensor 416 is provided in the discharge pipe s4 to sense the temperature. Oxygen, which is separated in the oxygen-water separation bath 404, is discharged through an oxygen-discharge pipe s5 to the outside, and the water is subjected to a re-circulation process.

The hydrogen gas, which is generated from the second electrochemical reaction chamber 422, entails water, and is moved through a discharge pipe s6 to the hydrogen-water separation bath 424 so as to be separated from water. A level sensor 426, which is used to sense the level, is provided in the hydrogen-water separation bath 424 so as to adjust the level. When the level of the hydrogen-water separation bath 424 is a predetermined value or more, an automatic valve 428 is opened (electric signal of e3) to supply the water through the circulation line s9 to the circulation pipe s2.

Meanwhile, the hydrogen gas, which is separated in the hydrogen-water separation bath 424, is supplied through a gas pipe s7 to a hydrogen-gas purifier 430 to thus remove moisture from hydrogen. Typically, a bed, which is filled with a moisture absorbent, is applied to the hydrogen gas purifier 430. The hydrogen that passes through the hydrogen gas purifier 430 is supplied through a high-purity hydrogen gas pipe s8 to a field requiring hydrogen. A pressure control valve 434 is provided in the high-purity hydrogen gas pipe s8 to control the pressure of the hydrogen gas generated from the electrolysis stack 420. Pressure sensors 432 and 438 are provided in the front and the rear of the pressure control valve 434 to measure pressure, and a check valve 436 is provided to maintain the flow of gas in a predetermined direction.

The aforementioned known MEA 100, the electrochemical cell 200, the electrochemical stack 300, and the hydrogen-generating system 400 have the following characteristics.

First, as shown in FIGS. 1 to 3, electrons are sequentially moved along an electron movement path through the first electrochemical catalyst 112, the first diffusion layer 102, the first electrochemical reaction chamber frame 208, the first current application plate 206, the power converter 224, the second current application plate 216, the pressure pad 304, the second electrochemical reaction chamber frame 214, the second diffusion layer 110, and the second electrochemical catalyst 116.

Second, as shown in FIG. 1, protons are sequentially moved along a proton movement path through the first electrochemical catalyst 112, the membrane 106, and the second electrochemical catalyst 116.

Third, each unit electrochemical cell includes the first electrochemical reaction chamber 210, in which the electrochemical reaction occurs due to the first electrochemical catalyst 112, and the second electrochemical reaction chamber 212, in which the electrochemical reaction occurs due to the second electrochemical catalyst 116. That is, the unit electrochemical cell includes the two electrochemical reaction chambers.

Fourth, the first electrochemical reaction chamber 210 is formed using the structure of the first electrochemical reaction chamber frame 208, and the second electrochemical reaction chamber 212 is formed using the structure of the second electrochemical reaction chamber frame 214. Therefore, the path of the electrons, which are moved through the solid portions of the first and the second electrochemical reaction chamber frames 208 and 214, meets the path of the reactant and the product, which are gas or liquid moving through the spaces in the first and the second electrochemical reaction chamber frames 208 and 214, to form a fluid path (refer to (A) of FIG. 2) for electron and electrolyte movement in the first and the second electrochemical reaction chambers 210 and 212.

In order to put the electrochemical cell to practical use, electric energy consumption must be reduced (the output density must be improved in the case of a fuel cell), durability must be improved, and costs must be reduced when water is electrolyzed. In this regard, the known MEA 100, electrochemical cell 200, and electrochemical stack 300 have the following drawbacks.

First, when the path through which the electrons generated using the first electrochemical catalyst 112 of FIGS. 1 and 2 are moved has a large resistance of about 215 μm or more, that is, when both paths have a resistance of 430 μm (215×2) or more, and is used to form the electrochemical stack 300 of FIG. 3, the electron movement path and the number of contact points increase exponentially, thereby causing an energy loss due to a voltage drop at the contact point to thus reduce the efficiency of electrolysis. That is, energy consumption is significantly increased during electrolysis.

Second, in the electrochemical cell 200 shown in FIG. 2, the electrons and the reactant/product are moved in the disposal direction of the first and the second electrochemical catalysts (that is, the same direction). Therefore, since the path of the electrons, which are moved through the solid, and the path of the reactant/product, which are moved through the space, must be provided separately, the fluid path is complicated, as in (A) of FIG. 2, thereby increasing manufacturing costs.

Third, the electrochemical cell 200 includes the first electrochemical reaction chamber frame 208 and the second electrochemical reaction chamber frame 214, that is, two electrolysis chambers, and accordingly, many elements are required in order to form the electrochemical stack 300, thereby increasing costs and reducing performance.

Fourth, in order to bring the elements into uniform contact with each other and maintain a desired pressure when a plurality of unit electrochemical cells is formed in the electrochemical stack 300, the elements must be very precisely processed, and accordingly, costs are increased.

Fifth, in order to bring the elements into uniform contact with each other and maintain desired pressure when the plurality of unit electrochemical cells is formed in the electrochemical stack 300, the structures of end plates and a clamping system combining the end plates are complicated, and great torque is required in order to perform clamping using the bolts 306 and the nuts 310. Accordingly, costs are increased.

### CITATION LIST

### Patent Document

Korean Patent No. 10-1357146

Korean Patent Application Publication No. 10-2008-0032962

### SUMMARY OF THE INVENTION

Accordingly, the present invention has been made keeping in mind the above problems occurring in the related art, and an object of the present invention is to provide a membrane electrode assembly and an electrochemical cell and an electrochemical stack using the same, in which an electron movement path and a fluid movement path are separated to reduce electric energy consumption, improve durability, and reduce manufacturing costs.

Another object of the present invention is to provide a membrane electrode assembly and an electrochemical cell and an electrochemical stack using the same, in which two electrochemical reaction layers of the MEA are included in an electrochemical reaction chamber in which an oxidation or reduction reaction occurs. Accordingly, the MEA is formed to be very compact, the number of parts is significantly reduced to thus significantly reduce the cost of manufacturing an electrochemical cell, and the number of contact points, which are causes of increased electrical resistance, is significantly reduced to thus significantly reduce electricity consumption during electrolysis and reduce operating costs.

In order to accomplish the above objects, the present invention provides a membrane electrode assembly that includes a polymer electrolyte membrane, a first electrochemical reaction layer formed on one side of the polymer electrolyte membrane to allow an oxidation reaction to occur thereon, a first electron-conductive layer formed between the polymer electrolyte membrane and the first electrochemical reaction layer, a second electrochemical reaction layer formed on a remaining side of the polymer electrolyte membrane to allow a reduction reaction to occur thereon, and a second electron-conductive layer formed between the polymer electrolyte membrane and the second electrochemical reaction layer.

Further, according to the present invention, the first electron-conductive layer and the second electron-conductive layer may each have a thickness of 0.1 to 5 μm.

Further, according to the present invention, the first electron-conductive layer and the second electron-conductive layer may include any one of platinum, palladium, rhodium, iridium, ruthenium, osmium, carbon, gold, tantalum, tin, indium, nickel, tungsten, and manganese.

Further, according to the present invention, the first electrochemical reaction layer and the second electrochemical reaction layer may each include a catalyst ink, and the catalyst ink may include an electrochemical catalyst, a carrier, a polymer electrolyte, and a solvent.

Further, according to the present invention, the electrochemical catalyst may include any one of platinum group elements including platinum, palladium, ruthenium, iridium, rhodium, and osmium, any one metal of iron, lead, copper, chromium, cobalt, nickel, manganese, vanadium, molybdenum, gallium, and aluminum, and alloys, oxides, and double oxides thereof.

Further, according to the present invention, the electrochemical catalyst may have a particle diameter of 0.5 to 20 nm.

Further, according to the present invention, the carrier may include any one of titanium oxides, carbon black, graphites, black lead, activated carbon, carbon fibers, carbon nanotubes, and fullerene.

Further, according to the present invention, the carrier may have a particle diameter of 10 to 1,000 nm.

In order to accomplish the above objects, the present invention also provides an electrochemical cell that includes the aforementioned membrane electrode assembly, first and second electrochemical reaction chamber frames, first and second insulating plates, and first and second end plates, which are sequentially arranged on both sides of the membrane electrode assembly, so that an oxidation or reduction reaction occurs and reactants and products are supplied and discharged, and a power converter connected to the first and the second electrochemical reaction chamber frames for the application of current. The first and the second electrochemical reaction chamber frames include respective electrochemical reaction chambers having first and second electrochemical reaction layers of the membrane electrode assembly.

In order to accomplish the above objects, the present invention also provides an electrochemical stack that includes a plurality of aforementioned membrane electrode assemblies, first and second electrochemical reaction chamber frames, first and second insulating plates, and first and second end plates, which are arranged sequentially in an outward direction on both sides of each of the membrane electrode assemblies, so that an oxidation or reduction reaction occurs and reactants and products are supplied and discharged, a plurality of third electrochemical reaction chamber frames disposed between the plurality of membrane electrode assemblies to each include an electrochemical reaction chamber, which includes two first or second electrochemical reaction layers of each of the membrane electrode assemblies, while the first and the second electrochemical reaction layers have the same oxidation or reduction reaction property, and a power converter connected to the first, the second, and the third electrochemical reaction chamber frames for the application of current.

According to the present invention, for an electron movement path, electrons are sequentially moved through an anode catalyst, an electron-conductive layer on a membrane, an external circuit, the electron-conductive layer on the membrane, and a cathode catalyst. Therefore, the electron movement path is short compared to a known electrochemical cell having an electron movement path, which is formed so that the electrons are sequentially moved through an anode catalyst, an anode-chamber diffusion layer, an anode-chamber current application plate, an external circuit, a pressure pad, a cathode-chamber current application plate, a cathode-chamber diffusion layer, and a cathode catalyst. Accordingly, the current density-voltage characteristics of the electrochemical cell are excellent, thereby reducing energy consumption during electrolysis.

Further, according to the present invention, since two electrochemical reaction layers of the MEA are included in an electrochemical reaction chamber, the MEA is formed to be very compact, and the number of parts is significantly reduced when an electrochemical stack is formed compared to the known electrochemical cell, thereby significantly reducing the cost of manufacturing the electrochemical cell.

Further, according to the present invention, the number of parts is significantly reduced when the electrochemical stack is formed, compared to the known electrochemical cell. Accordingly, the number of contact points, which are a cause of increased electrical resistance, is significantly reduced compared to the known electrochemical cell, thereby significantly reducing electricity consumption during electrolysis and reducing operating costs.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view showing the concept of an MEA, which is a portion of a typical electrolytic cell that electrochemically decomposes water to produce hydrogen and oxygen gases;

FIG. 2 is a view showing the structure of a typical electrochemical cell which includes the MEA of FIG. 1 to electrolyze water;

FIG. 3 is a view showing the concept of a known electrochemical stack;

FIG. 4 is a view showing a system for electrolyzing water using the electrochemical stack of FIG. 3 to produce hydrogen;

FIG. 5 is a view showing an MEA according to an embodiment of the present invention;

FIG. 6 is a view showing the structure of an electrochemical cell including the MEA shown in FIG. 5;

FIG. 7 is a view showing the concept of an electrochemical stack including the electrochemical cells of FIG. 6 layered therein;

FIG. 8 is a comparative graph showing the performance of Example 1 of the present invention and Comparative Example 1; and

FIG. 9 is a comparative graph showing the performance of Example 2 of the present invention and Comparative Example 2.

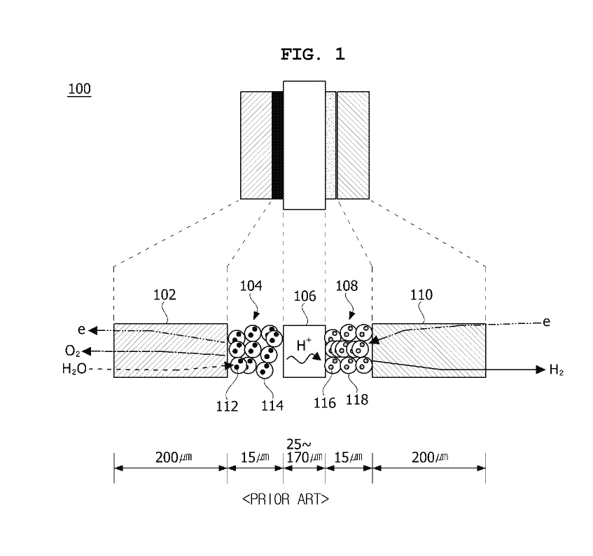

### DESCRIPTION OF THE PREFERRED EMBODIMENTS

Hereinafter, preferred embodiments of the present invention will be described in detail with reference to the appended drawings so as to easily perform the present invention by the person having ordinary skill in the related art. However, descriptions of known techniques, even if they are pertinent to the present invention, are considered unnecessary and may be omitted insofar as they would make the characteristics of the invention unclear. Furthermore, the same or similar portions are represented using the same reference numeral in the drawings.

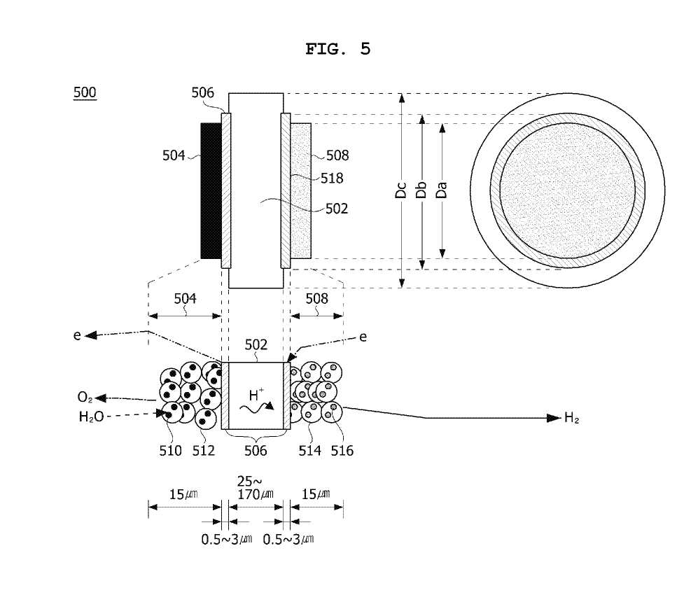

FIG. 5 is a view showing an MEA according to an embodiment of the present invention. As shown in FIG. 5, an MEA 500 according to the embodiment of the present invention includes a first electron-conductive layer 506, a first electrochemical reaction layer 504, a membrane 502, a second electron-conductive layer 518, and a second electrochemical reaction layer 508. The first electron-conductive layer 506 and the first electrochemical reaction layer 504 are sequentially formed on one side of the membrane 502, and the second electron-conductive layer 518 and the second electrochemical reaction layer 508 are sequentially formed on the remaining side of the membrane 502.

An electrolysis reaction of water in the MEA 500 of the present embodiment will be described below. The description will be given on the assumption that an oxidation reaction (oxygen generation reaction) occurs at a first electrochemical catalyst and a reduction reaction (hydrogen generation reaction) occurs at a second electrochemical catalyst.

First, when water (H₂O) is supplied to a first electrochemical catalyst 510 (oxidation catalyst, oxygen catalyst), water is decomposed into oxygen gas (O₂), electrons (e⁻), and hydrogen ions (H⁺) (protons). A portion of the water (H₂O) is discharged to the outside together with the oxygen gas (O₂), and the hydrogen ions (H⁺), which are obtained due to decomposition, are moved through the membrane 502 to a second electrochemical catalyst 516 (reduction electrode, hydrogen electrode). In addition, the electrons are moved along the first electron-conductive layer 506, which is formed on the membrane 502, and an external circuit (not shown). Meanwhile, the electrons (e⁻) moving along the external circuit (not shown), through which the first electron-conductive layer 506 and the second electron-conductive layer 518 are connected, and the hydrogen ions moving from the first electrochemical catalyst 510 are reacted to generate hydrogen gas. In addition, water (H₂O), which passes through the membrane 502 together with the hydrogen ions (H⁺), is discharged together with the hydrogen gas to the outside of an electrolytic cell. The electrochemical reaction that occurs under the first and the second electrochemical catalysts 510 and 516 is shown in the aforementioned Reaction Schemes 1 and 2.

Any membrane may be used as the membrane 502 of the present embodiment as long as the membrane has hydrogen ion (proton) conductivity, and a fluorine-based polymer electrolyte and a hydrocarbon-based polymer electrolyte may be used. Examples of the fluorine-based polymer membrane may include Nafion (Registered trademark), manufactured by the DuPont Company, Flemion (Registered trademark), manufactured by Asahi Glass Co., Ltd., Aciplex (Registered trademark) manufactured by Asahi Kasei Corporation, and Gore Select (Registered trademark) manufactured by Gore & Associates, Inc. Examples of the hydrocarbon-based polymer membrane may include an electrolyte membrane such as sulfonated polyether ketone, sulfonated polyether sulfone, sulfonated polyether ether sulfone, sulfonated polysulfide, and sulfonated polyphenylene. Among the aforementioned examples, it is preferable to use a Nafion (Registered trademark)-based material, which is manufactured by the DuPont Company, as the polymer membrane.

The first and the second electron-conductive layers 506 and 518 of the present embodiment are formed on either side of the membrane 502, and function to conduct electrons. The first and the second electron-conductive layers 506 and 518 formed on the membrane 502 are 0.1 to 5 μm and preferably 0.5 to 3 μm in thickness. The reason is that when the first and the second electron-conductive layers 506 and 518 have a thickness of 0.1 μm or less, resistance is increased while the electrons are moved through the electron-conductive layer, and when the electron-conductive layer has a thickness of 5 μm or more, an excessively thick electron-conductive layer is formed, obstructing movement of the protons and thus reducing ion conductivity. Examples of the material of the first and the second electron-conductive layers 506 and 518 include metals having excellent conductivity, such as platinum, palladium, rhodium, iridium, ruthenium, osmium, carbon, gold, tantalum, tin, indium, nickel, tungsten, and manganese. Platinum groups are preferable in terms of chemical resistance.

The first and the second electrochemical reaction layers 504 and 508 of the present embodiment are formed on either side of the membrane 502 having the first and the second electron-conductive layers 506 and 518. The first and the second electrochemical reaction layers 504 and 508 are formed using a catalyst ink. The catalyst ink for the first electrochemical reaction layer 504 includes at least a first electrochemical catalyst 510, a carrier 512, a polymer electrolyte, and a solvent, and the catalyst ink for the second electrochemical reaction layer 508 includes at least a second electrochemical catalyst 516, a carrier 514, a polymer electrolyte, and a solvent.

Examples of the polymer electrolyte included in the catalyst ink of the present embodiment may include a fluorine-based polymer electrolyte and a hydrocarbon-based polymer electrolyte exhibiting proton conductivity. In addition, examples of the fluorine-based polymer electrolyte may include a Nafion (Registered trademark)-based material manufactured by the DuPont Company. Examples of the hydrocarbon-based polymer electrolyte may include an electrolyte such as sulfonated polyether ketone, sulfonated polyether sulfone, sulfonated polyether ether sulfone, sulfonated polysulfide, and sulfonated polyphenylene. In consideration of adhesion of the first and the second electrochemical reaction layers 504 and 508 and the first and the second electron-conductive layers 506 and 518, it is preferable to use the same material as the membrane 502, among the aforementioned examples.

Examples of the first and the second electrochemical catalysts 510 and 516, which are used in the present embodiment, may include platinum group elements including platinum, palladium, ruthenium, iridium, rhodium, and osmium, metal such as iron, lead, copper, chromium, cobalt, nickel, manganese, vanadium, molybdenum, gallium, and aluminum, or alloys, oxides, or double oxides thereof. It is preferable to use one or more metals, which are selected from platinum, palladium, rhodium, ruthenium, and iridium, or oxides thereof in order to ensure excellent electrode reactivity and effectively perform a stable electrode reaction over a long period of time.

In the present embodiment, when the particle diameter of the first and the second electrochemical catalysts 510 and 516 is very large, the activity of the catalyst is reduced, and when the particle diameter is very small, the stability of the catalyst is reduced. Accordingly, the particle diameter is preferably 0.5 to 20 nm, and more preferably 1 to 5 nm.

Meanwhile, carriers 512 and 514 for carrying the catalyst include powder that exhibits electron conductivity, and titanium oxide or carbon particles may be used. The carrier is provided in a fine particle form and exhibits conductivity, and any carrier may be used as long as the carrier does not intrude the catalyst. However, it is preferable to use titanium oxides, carbon black, graphites, black lead, activated carbon, carbon fibers, carbon nanotubes, or fullerene.

In addition, when the particle diameter of the carriers 512 and 514 is very small, it is difficult to form an electron-conductive path, and when the particle diameter is very large, the diffusion of gas into the electrode catalyst layer formed on the carrier is reduced, or the availability of the catalyst is reduced. Accordingly, the particle diameter is preferably 10 to 1,000 nm, and more preferably 10 to 100 nm.

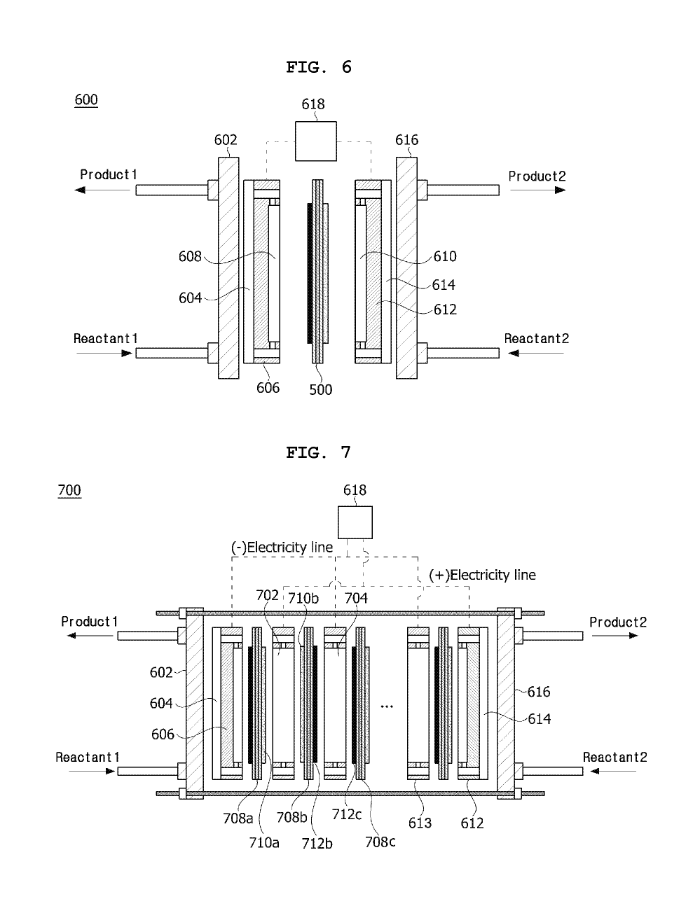

Preferably, the size Dc of the membrane 502 of the present embodiment is larger than that of first and second electrochemical reaction chamber frames 606 and 612 shown in FIG. 6, the size Db of the first and the second electron-conductive layers 506 and 518 is smaller than that of the first and the second electrochemical reaction chamber frames 606 and 612 shown in FIG. 6, and the size Da of the first and the second electrochemical reaction layers 504 and 508 is the same as the internal area of first and second electrochemical reaction chambers 608 and 610.

A method of manufacturing an MEA according to the embodiment of the present invention will be described hereinafter.

Process 1: Pre-Treatment Process of the Membrane 502

Pre-treatment of the membrane 502 is a process which includes roughening the surface of the membrane using a mechanical process, and physically and chemically treating organic and inorganic impurities present in the membrane 502. The process will be described in detail below.

Process 2: Process of Forming the First and the Second Electron-Conductive Layers 506 and 518

The membrane 502 obtained during process 1 is precipitated in a metal precursor solution for a predetermined time and then reduced to form a metal thin film layer, which has an electron-conductive function, on the membrane 502. The precipitation and reduction processes are repeated to form the metal thin film layer having a predetermined thickness. The processes will be described in detail below.

Process 3: Process of Forming the First and the Second Electrochemical Reaction Layers 504 and 508

Process 3 is a process of forming the first and the second electrochemical reaction layers 504 and 508 on the membrane 502 which has the first and the second electron-conductive layers 506 and 518 obtained during process 2. Process 3 includes a catalyst synthesis process, a catalyst ink manufacturing process, a catalyst ink transfer process, and a thermal-pressing process. The catalyst synthesis process includes forming mixture oxides, using a reaction of a desired catalyst precursor and an oxidant, and drying the mixture oxides to obtain an electrochemical catalyst having a powder structure. The catalyst ink manufacturing process includes mixing the electrochemical catalyst, which is synthesized during the catalyst synthesis process, a particulate material, a dispersant, and a binder made of the same material as the membrane 502 to manufacture the catalyst ink. Further, the catalyst ink transfer process includes transferring the catalyst ink, which is manufactured during the catalyst ink manufacturing process, onto a Teflon sheet using a spray and then drying the catalyst ink. The thermal-pressing process includes attaching the Teflon sheet, which is obtained during the catalyst ink transfer process, to both sides of the membrane 502 having the first and the second electron-conductive layers 506 and 518, which are formed during process 2, and then thermal-pressing the Teflon sheet using a hot press. The processes will be described in detail below.

FIG. 6 is a view showing the structure of an electrochemical cell including the MEA shown in FIG. 5. As shown in FIG. 6, an electrochemical cell 600 of the present embodiment includes a first end plate 602, a first insulating plate 604, a first electrochemical reaction chamber frame 606, a first electrochemical reaction chamber 608, the MEA 500, a second electrochemical reaction chamber 610, a second electrochemical reaction chamber frame 612, a second insulating plate 614, and a second end plate 616. A direct current power supply is used as a power converter 618 for driving the electrochemical cell 600.

Bolt/nut fastening holes (not shown) are formed through the first end plate 602 and the second end plate 616 in order to assemble the electrochemical cell 600, and paths (not shown), through which reactants and products are moved, are provided in the first end plate 602 and the second end plate 616. The first insulating plate 604 and the second insulating plate 614 function to electrically insulate electrolysis elements between the first end plate 602 and the second end plate 616, and the first electrochemical reaction chamber frame 606 and the second electrochemical reaction chamber frame 612 are connected to the power converter 618 to apply required current to the electrochemical cell 600.

The electrochemical cell 600 of the present embodiment has a structure that includes the first electrochemical reaction chamber 608, in which an oxidation reaction (oxygen reaction) occurs, the second electrochemical reaction chamber 610, in which a reduction reaction (hydrogen reaction) occurs, and the MEA 500 between the first electrochemical reaction chamber 608 and the second electrochemical reaction chamber 610, which face each other. Meanwhile, the first electrochemical reaction chamber frame 606 functions to isolate the first electrochemical reaction chamber 608 from the outside, and the second electrochemical reaction chamber frame 612 functions to isolate the second electrochemical reaction chamber 610 from the outside. The first and the second electrochemical reaction chamber frames 606 and 612 face each other while the MEA 500 is interposed therebetween.

The first and the second electrochemical reaction chamber frames 606 and 612 may have predetermined holes, through which reactants required in the electrochemical cell 600 or products formed during the electrochemical reaction are easily supplied or discharged, and may also have a terminal which is used to draw and apply current.

FIG. 7 is a view showing the concept of an electrochemical stack including the electrochemical cells of FIG. 6 layered therein. As shown in FIG. 7, an electrochemical stack 700 of the present embodiment includes unit electrochemical cells which are repeatedly provided in a desired number (for example, n cells) between the basic electrochemical cells 600. A plurality of MEAs 500 is provided so that the MEA is disposed between the unit electrochemical cells. Third electrochemical reaction chamber frames 613 having a first electrochemical reaction chamber 702 and a second electrochemical reaction chamber 704 are provided on either side of the MEA 500, and the unit electrochemical cells are repeatedly provided while the first electrochemical reaction chamber 702 and the second electrochemical reaction chamber 704 are alternately disposed.

The first electrochemical reaction chamber 702 has a structure that includes a first electrochemical reaction layer 710a of a first MEA 708a and a second electrochemical reaction layer 710b of a second MEA 708b, and the second electrochemical reaction chamber 704 has a structure that includes a second electrochemical reaction layer 712b of the second MEA 708b and a third electrochemical reaction layer 712c of a third MEA 708c. That is, the two electrochemical reaction layers having the same oxidation or reduction reaction properties are included in each of the electrochemical reaction chambers.

The first and the second electrochemical reaction chamber frames 606 and 612 function to isolate the first and second electrochemical reaction chambers 702 and 704 from the outside. Meanwhile, the power converter 618 is connected to the first, second, and third electrochemical reaction chamber frames 606, 612 and 613. In order to provide each electrochemical reaction environment, a positive (+) pole is connected to the power converter 618 when the oxidation reaction is induced, and a negative (−) pole is connected to the power converter 618 when the reduction reaction is induced.

In the electrochemical stack 700 of the present embodiment, bolts 720 are fastened with nuts through holes, which are formed through the first and the second end plates 602 and 616, to assemble the electrochemical cells.

Hereinafter, the method of manufacturing the membrane electrode assembly according to Examples of the aforementioned embodiment and Comparative Examples will be specifically described, and experimental results will be given. However, the present invention is not limited to the following Examples.

### Example 1

1. Manufacture of the MEA 500

(1) Process 1: Pre-Treatment Process of the Membrane 502

Both surfaces of the membrane 502 (Nafion 117) were scratched in four directions using sandpaper (Emery sand paper 1100CW), and then subjected to the swelling process in pure water at 90° C. Impurities were removed from the membrane, which was subjected to the swelling process, using ultrasonic wave treatment in pure water, and the membrane was treated in 3% hydrogen peroxide (H₂O₂) for 30 min and in 0.5 to 1M sulfuric acid (H₂SO₄) at 90° C. for 30 min, and then subjected to the aforementioned pure water process again.

(2) Process 2: Process of Forming First and Second Electron-Conductive Layers 506 and 518

The membrane 502, which was subjected to process 1, was precipitated in the platinum chloride ((NH₃)₄PtCl₂*H₂O) precursor solution for 5 hours. The precipitated polymer electrolyte membrane was washed with pure water, and the NaBH₄ solution was dripped for 2 hours, during which one drop fell every 20 min, in order to reduce the metal precursor. After reduction, the polymer electrolyte membrane having the electron layer was dipped in the NaOH solution at 90° C. for 1 hour to be treated and then washed with pure water. The aforementioned precipitation reduction process was repeated a predetermined number of times to form first and second electron-conductive layers 506 and 518 on the membrane 502.

(3) Process 3: Process of Forming First and Second Electrochemical Reaction Layers 504 and 508

During the process of forming the first and the second electrochemical reaction layers 504 and 508, the first and the second electrochemical reaction layers 504 and 508 were formed on the membrane 502 having the first and the second electron-conductive layers 506 and 518. The process of forming the first and the second electrochemical reaction layers 504 and 508 included a process of synthesizing first and second electrochemical catalysts 510 and 516, a process of manufacturing ink for the first and the second electrochemical catalysts 510 and 516, a process of transferring ink for the first and the second electrochemical catalysts 510 and 516, and a thermal-pressing process.

(3-1) Process 3-1: Process of Synthesizing the First and the Second Electrochemical Catalysts 510 and 516

(3-1-1) Synthesis of the First Electrochemical Catalyst 510

An oxidized iridium-ruthenium mixture catalyst was manufactured using a reaction of iridium chlorides (IrCl₃.xH₂O) and ruthenium chlorides (RuCl₃.xH₂O) in a sodium nitrate solution. In addition, iridium chlorides and ruthenium chlorides were agitated in the solution having sodium nitrates dissolved therein for about 2 hours to be uniformly dissolved. The manufactured mixture catalyst solution was heated to 100° C. to vaporize distilled water for 1 hour to thus perform concentration, and the concentrate was sintered in an electric furnace at 475° C. for 1 hour and then slowly cooled. Subsequently, the resulting material was washed with 9L of distilled water and filtered in order to remove generated sodium chlorides. The obtained solid was dried at 80° C. for 12 hours to manufacture a final iridium-ruthenium electrochemical mixture catalyst.

(3-1-2) Synthesis of the Second Electrochemical Catalyst 516

Commercially available Pt/C (Premetek Inc., amount of carried platinum of 30%) was used as the second electrochemical catalyst 516.

(3-2) Process 3-2: Process of Manufacturing Ink for the First and the Second Electrochemical Catalysts 510 and 516

(3-2-1) Manufacture of Ink for the First Electrochemical Catalyst 510 (the Catalyst at the Oxygen Side)

The oxidized iridium-ruthenium catalyst, which was manufactured during process 3-1, nano-sized titanium dioxides as the carrier, and the Nafion solution as the binder were used, and the used catalyst and Nafion ionomers were mixed in an isopropyl alcohol solvent at a ratio of 1:3.5 based on the weight of the solid. Agitation for 1 hour and ultrasonic wave treatment for 1 hour were alternately performed twice in order to disperse the catalyst.

(3-2-2) Manufacture of Ink for the Second Electrochemical Catalyst 516 (the Catalyst at the Hydrogen Side)

Pt/C (Premetek Inc., amount of carried platinum of 30%) was used as the second electrochemical catalyst 516, and the Nafion solution (a registered product from DuPont) was used as the binder. The used catalyst and Nafion solution were mixed in an isopropyl alcohol solvent at a ratio of 1:7.5 based on the weight of the solid. Agitation for 1 hour and ultrasonic wave treatment for 1 hour were alternately performed twice in order to disperse the catalyst.

(3-3) Process 3-3: Process of Transferring the First and the Second Electrochemical Catalysts 510 and 516

(3-3-1) Transferring of the First Electrochemical Reaction Layer 504

The polytetrafluoroethylene (PTFE) sheet was used as the transfer sheet. The ink for the first electrochemical catalyst 510, which was obtained during process 3-2, was moved to a syringe for electrospraying only. The catalyst ink was transferred onto the base material and then dried in the atmosphere at 90° C. for 30 min to manufacture an electrochemical catalyst layer. The amount of carried oxide catalyst was adjusted to about 4 mg/cm² to set the thickness of the first electrochemical reaction layer 504.

(3-3-1) Transferring of the Second Electrochemical Reaction Layer 518

The ink for the second electrochemical catalyst 516, which was obtained during process 3-2, was moved to a syringe for electrospraying only. The catalyst ink was transferred onto the carbon sheet and then dried in the atmosphere at 90° C. for 30 min to manufacture an electrochemical catalyst layer. The amount of the carried oxide catalyst was adjusted to about 1 mg/cm² to set the thickness of the second electrochemical reaction layer 518.

(3-4) Process 3-4: Thermal-Pressing Process

(3-4-1) Formation of the First Electrochemical Reaction Layer 504

The first electrochemical catalyst 510, which was obtained during process 3-3 and loaded on the Teflon sheet, was thermal-pressed twice on the membrane 502, which was obtained during process 2, under a condition of 120° C. and pressure of 10 MPa for 3 min. The Teflon sheet was removed to transfer the catalyst.

(3-4-2) Formation of the Second Electrochemical Reaction Layer 508

The carbon sheet, on which the manufactured second electrochemical catalyst 516 was loaded, was thermal-pressed under a condition of 120° C. and pressure of 10 MPa for 2 min on the opposite surface of the membrane 502, with which the manufactured first electrochemical reaction layer 504 was combined, to obtain the MEA 500 shown in FIG. 5.

2. Electrochemical Cell for Evaluation and Evaluation System

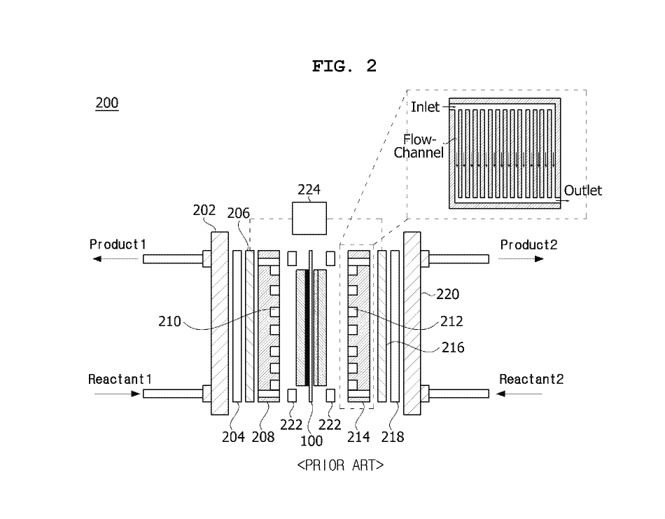

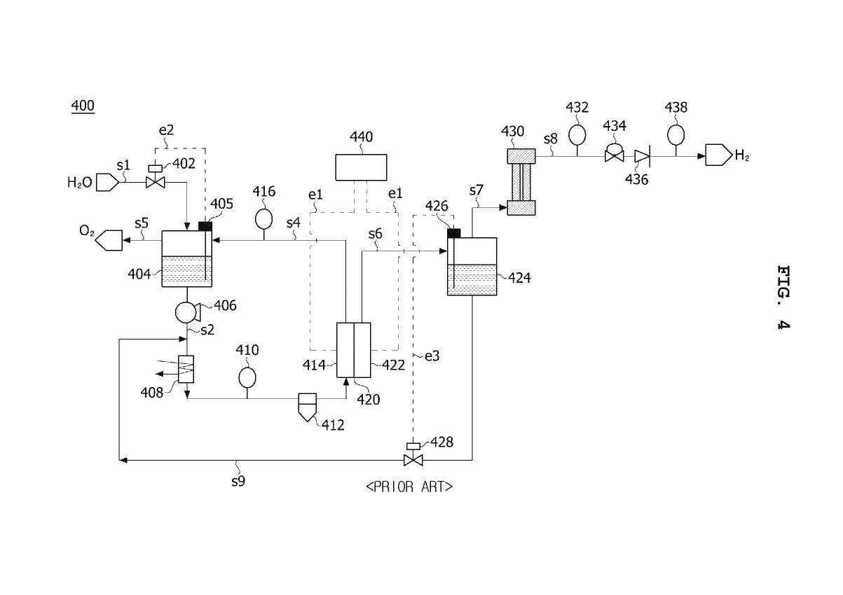

Titanium fibers, as a first diffusion layer 102, and carbon fibers, as a second diffusion layer 110, were attached to the MEA (electrochemically active area (Da=9 cm²)), which had the same constitution as Example 1 and included the electron-conductive layer having the thickness of 2 μm, so as to support the MEA. The resulting structure was evaluated using the cell for evaluation shown in FIG. 2. The diffusion layers were pressed on both sides of the MEA using a hot-press device at a high temperature of about 80 to 200° C. under a pressure of about 1 to 20 Mpa so as to support the MEA. The cell temperature was maintained at 80° C. (temperature sensor 416 of FIG. 4), and the current and voltage of the electrolytic cell were measured. Meanwhile, the discharge pressure of hydrogen (adjusted using s8 and 434 of FIG. 4) was maintained at about 10 bar.

3. Measurement Result

From FIG. 8, it can be seen that the voltage of the MEA, manufactured in Example 1, was slightly changed even when the current density was increased.

### Comparative Example 1

1. Manufacture of the MEA (Manufacture of the MEA According to a Known Method)

The pre-treatment process of the membrane and the processes of forming the first and the second electrochemical reaction layers were performed using the same procedure and conditions as Example 1, and the processes of forming the first and the second electron-conductive layers were not performed in order to compare Comparative Example 1 and Example 1.

2. Electrochemical Cell for Evaluation and Evaluation System

The MEA (electrochemically active area of 314 cm²) of Comparative Example 1 was evaluated using the same electrochemical cell and evaluation system as Example 1.

3. Measurement Result

From FIG. 8, it can be seen that the voltage is significantly increased as the current density is increased.

### Evaluation of Example 1 and Comparative Example 1

FIG. 8 shows the current density-voltage characteristic of the MEAs of Example 1 and Comparative Example 1, region (1) shows the high and low performance, depending on the electrochemical catalyst, and region (2) is a high current density region. The constitutions of the electrochemical catalyst of Example 1 and the electrochemical catalyst of Comparative Example 1 are the same. Accordingly, from FIG. 8, it can be seen that the membrane of Example 1 and the membrane of Comparative Example 1 have similar performance in region (1). However, the membrane including the electron-conductive layer of Example 1 has excellent ability to conduct the electrons to the electrochemical reaction layer. Accordingly, it can be seen that the membrane of Example 1 has low voltage characteristics compared to the membrane of Comparative Example 1 in region (2), which is the high current density region.

### Example 2

1. Manufacture of the MEA

The MEA was manufactured using the same procedure and conditions as Example 1.

2. Electrochemical Stack and Evaluation System

The MEA of Example 1 was used to manufacture the electrochemical stack shown in FIG. 7, which was then evaluated. The electrochemical catalyst layer had an area of 314 cm², and the electrochemical stack was sized to include ten layered unit electrochemical cells. As for the operating conditions, the temperature and the pressure were the same as in Example 1.

3. Measurement Result

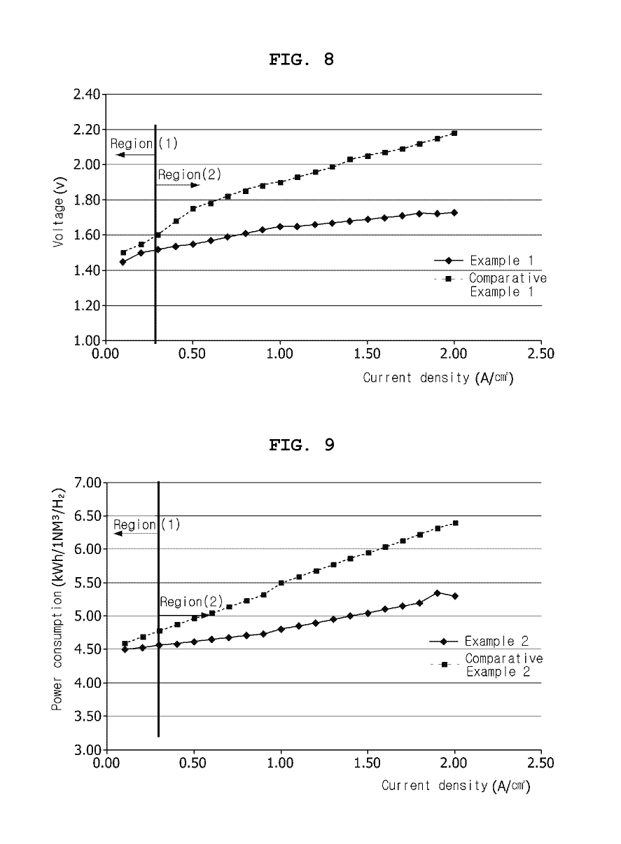

From FIG. 9, it can be seen that the power consumption of the MEA, which is manufactured in Example 2, is slightly changed even when the current density is increased.

### Comparative Example 2

1. Manufacture of the MEA

The MEA was manufactured using the same procedure and condition as Comparative Example 1.

2. Electrochemical Stack

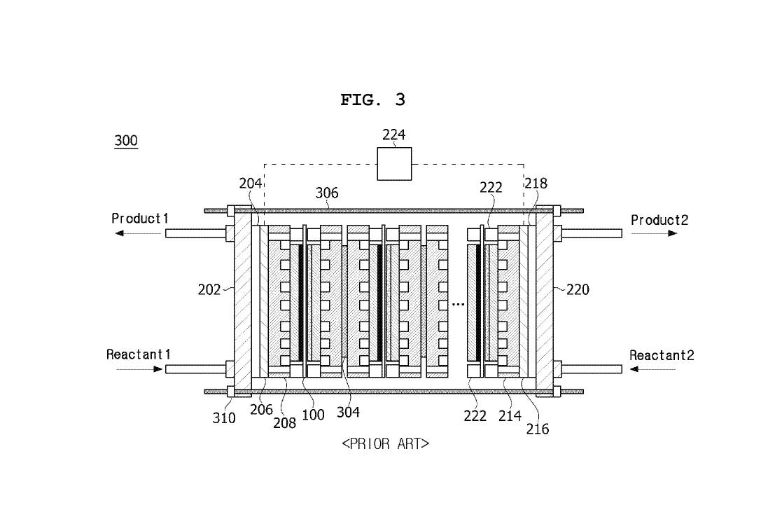

The MEA of Comparative Example 1 was used to manufacture the electrochemical stack shown in FIG. 3, which was then evaluated. As in Example 2, the electrochemical catalyst layer had an area of 314 cm², and the electrochemical stack was sized to include ten layered unit electrochemical cells. As for the operating conditions, the temperature and the pressure were the same as in Example 1.

C. Measurement Result

From FIG. 9, it can be seen that the power consumption was significantly increased as the current density was increased.

### Evaluation of Example 2 and Comparative Example 2

FIG. 9 shows the current density-power consumption characteristic of the electrochemical stacks of Example 2 and Comparative Example 2, region (1) shows the high and low performance, depending on the electrochemical catalyst, and region (2) shows the high and low performance, depending on elements other than the electrochemical catalyst. From FIG. 9, it can be seen that constitutions of the electrochemical catalysts of Example 2 and Comparative Example 2 are the same in region (1), and accordingly, the electrochemical stacks have similar performance. However, the electrochemical stack structure including the electron-conductive layer of Example 2 has excellent electron-conductive ability. Accordingly, it can be seen that energy consumption is lower in the electrochemical stack of Example 2 than in the electrochemical stack of Comparative Example 2 in region (2) when hydrogen is generated.

As described above, the electrochemical cell of the present invention has electron-conductive ability that is better than that of a known electrochemical cell, that is, has a short electron movement path. Accordingly, the current density-voltage characteristics of the electrochemical cell of the present invention are excellent, thus reducing energy consumption during electrolysis. In other words, in the related art, electrons are sequentially moved through an anode catalyst, an anode-chamber diffusion layer, an anode-chamber current application plate, an external circuit, a pressure pad, a cathode-chamber current application plate, a cathode-chamber diffusion layer, and a cathode catalyst to thus form the electron movement path. However, according to the present invention, the electrons are sequentially moved through an anode catalyst, an electron-conductive layer on a membrane, an external circuit, the electron-conductive layer on the membrane, and a cathode catalyst to thus form the electron movement path. Therefore, the electrochemical cell of the present invention has an electron movement path that is shorter than that of the known electrochemical cell, and accordingly, the current density-voltage characteristics of the electrochemical cell may be excellent due to the short electron movement path, thereby reducing energy consumption during electrolysis.

Further, since each electrochemical reaction chamber of the present invention includes the two electrochemical reaction layers of the MEA, the MEA is formed to be very compact, and the number of parts is significantly reduced when the electrochemical stack is formed compared to the known electrochemical cell, thereby significantly reducing the cost of manufacturing the electrochemical cell. In other words, each electrochemical reaction chamber includes the two electrochemical reaction layers of the MEA when the electrochemical cells are formed, and accordingly, the electrochemical stack of the present invention has the number of parts described in Table 1. However, the known electrochemical stack includes even more parts compared to the electrochemical stack of the present invention.

TABLE 1

| | | | | | | Electrochemical stack of the | | | | |
|---|---|---|---|---|---|---|---|---|---|---|
| | Known electrochemical stack | | | | | present invention | | | | |
| | N = 1 | N = 2 | N = 3 | N = 4 | N = n | N = 1 | N = 2 | N = 3 | N = 4 | N = n |
| End plate | 2 | 2 | 2 | 2 | 2 | | 2 | 2 | 2 | 2 |
| Diffusion layer | 2 | 4 | 6 | 8 | 2n | | | | | |
| Pressure pad | 1 | 2 | 3 | 4 | n | | | | | |
| Electrochemical | 2 | 4 | 6 | 8 | 2n | | 3 | 4 | 5 | n + 1 |
| reaction chamber frame | | | | | | | | | | |
| MEA | 1 | 2 | 3 | 4 | n | | 2 | 3 | 4 | n |
| Total | 8 | 14 | 20 | 26 | 6n + 2 | | 7 | 9 | 11 | 2n + 3 |

In addition, as described above, the number of parts, which constitute the electrochemical stack of the present invention, is significantly reduced compared to a known electrochemical cell. Accordingly, as in Table 2, the number of contact points, which are causes of increased electrical resistance, may be significantly reduced compared to the known electrochemical cell, to thus significantly reduce electricity consumption during electrolysis and also reduce operating costs.

TABLE 2

| | | | | | | Electrochemical stack of the | | | | |
|---|---|---|---|---|---|---|---|---|---|---|
| | Known electrochemical stack | | | | | present invention | | | | |
| | N = 1 | N = 2 | N = 3 | N = 4 | N = n | N = 1 | N = 2 | N = 3 | N = 4 | N = n |
| Number of contact resistors | 6 | 11 | 16 | 21 | 5n + 5 | 4 | 8 | 12 | 16 | 4n |

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A membrane electrode assembly comprising:
a polymer electrolyte membrane;
a first electrochemical reaction layer formed on one side of the polymer electrolyte membrane to allow an oxidation reaction to occur thereon;
a first electron-conductive layer formed between the polymer electrolyte membrane and the first electrochemical reaction layer;
a second electrochemical reaction layer formed on a remaining side of the polymer electrolyte membrane to allow a reduction reaction to occur thereon; and
a second electron-conductive layer formed between the polymer electrolyte membrane and the second electrochemical reaction layer.

2. The membrane electrode assembly of claim 1, wherein the first electron-conductive layer and the second electron-conductive layer each have a thickness of 0.1 to 5 μm.

3. The membrane electrode assembly of claim 1, wherein the first electron-conductive layer and the second electron-conductive layer include any one of platinum, palladium, rhodium, iridium, ruthenium, osmium, carbon, gold, tantalum, tin, indium, nickel, tungsten, and manganese.

4. The membrane electrode assembly of claim 1, wherein the first electrochemical reaction layer and the second electrochemical reaction layer each include a catalyst ink, and the catalyst ink includes an electrochemical catalyst, a carrier, a polymer electrolyte, and a solvent.

5. The membrane electrode assembly of claim 4, wherein the electrochemical catalyst includes any one of platinum group elements of platinum, palladium, ruthenium, iridium, rhodium, and osmium, any one metal of iron, lead, copper, chromium, cobalt, nickel, manganese, vanadium, molybdenum, gallium, and aluminum, and alloys, oxides, and double oxides thereof.

6. The membrane electrode assembly of claim 4, wherein the electrochemical catalyst has a particle diameter of 0.5 to 20 nm.

7. The membrane electrode assembly of claim 4, wherein the carrier includes any one of titanium oxides, carbon black, graphites, black lead, activated carbon, carbon fibers, carbon nanotubes, and fullerene.

8. The membrane electrode assembly of claim 4, wherein the carrier has a particle diameter of 10 to 1,000 nm.

9. An electrochemical cell comprising:
the membrane electrode assembly of claim 1;
first and second electrochemical reaction chamber frames, first and second insulating plates, and first and second end plates, which are sequentially arranged on both sides of the membrane electrode assembly, so that an oxidation or reduction reaction occurs and reactants and products are supplied and discharged; and
a power converter connected to the first and the second electrochemical reaction chamber frames for application of a current,
wherein the first and the second electrochemical reaction chamber frames include respective electrochemical reaction chambers having first and second electrochemical reaction layers of the membrane electrode assembly.

10. An electrochemical stack comprising:
a plurality of membrane electrode assembly of claim 1;
first and second electrochemical reaction chamber frames, first and second insulating plates, and first and second end plates, which are arranged sequentially in an outward direction on both sides of each of the membrane electrode assemblies, so that an oxidation or reduction reaction occurs and reactants and products are supplied and discharged;
a plurality of third electrochemical reaction chamber frames disposed between the plurality of membrane electrode assemblies to each include an electrochemical reaction chamber, which includes two first or second electrochemical reaction layers of each of the membrane electrode assemblies, while the first and the second electrochemical reaction layers have a same oxidation or reduction reaction property; and
a power converter connected to the first, the second, and the third electrochemical reaction chamber frames for application of a current.
